(19) United States
(12) Patent Application Publication
(10) Pub. No.: US 2021/0012605 A1
(43) Pub. Date: Jan. 14, 2021

(54) METHODS OF RECYCLABLE ELECTRONIC BASED REWARD SYSTEM FOR INVOKING PROPER RECYCLING PROCEDURES

(71) Applicants: Elias YAMINE, Tulsa, OK (US); Alexander YAMINE, Tulsa, OK (US)

(72) Inventors: Elias YAMINE, Tulsa, OK (US); Alexander YAMINE, Tulsa, OK (US)

(21) Appl. No.: 16/925,450

(22) Filed: Jul. 10, 2020

Related U.S. Application Data
(60) Provisional application No. 62/872,531, filed on Jul. 10, 2019.

(51) Int. Cl. G07F 7/06; H04W 4/80; G06Q 20/06; G06Q 20/36; H04L 9/06; H04L 9/32; B65F 1/00; B65F 1/14

(52) U.S. Cl. CPC G07F 7/06; H04W 4/80; G06Q 20/065; G06Q 20/363; H04L 2209/38; H04L 9/3231; B65F 1/0006; B65F 1/1484; H04L 9/0637

(57) ABSTRACT

The invention relates to tracking and analyzing human behavior through a network and granting compensation to participants through adjusting rewards for said behaviors associated with improving their recycling habits.

The present invention relates to methods of improving recycling behavior in humans through intelligent social and financial compensation. In particular, the invention relates to tracking and analyzing human behavior through a network and granting compensation to participants through adjusting rewards for said behaviors associated with improving their recycling habits.

### BACKGROUND OF THE INVENTION

Societies that refuse to recycle and live an eco-friendly lifestyle will only speed up the environmental decline. For most people there's no point in recycling because they see that landfills are now overfilled with lots of recyclable material and they believe their individual participation doesn't matter. Also the inconvenience of recycling for both the recycler and recycling collector is greater than the reward. Because the monetary value of the recycled goods is minuscule and the effort to collect, separate and store recycled waste, people simply overlook the slow decline of their environment.

By the time the recycling participants recognize their environmental decline, it is overwhelming and they've already adjusted their behavior to accept their new life living among the waste as “normal” Waste in garbage bins begin to overflow into the streets causing a number of health problems in a modern society. This is due to the non-separation of recyclable materials being thrown in with recyclable materials.

Overflowing garbage can cause air pollution, which also causes various respiratory diseases and other adverse health effects as contaminants are absorbed from lungs into other parts of the body. The toxic substances in air contaminated by waste include carbon dioxide, nitrous oxide and methane. In everyday life we identify the polluted air especially through bad odors, which are usually caused by decomposing and liquid waste items.

Garbage and liquid waste that end up in water bodies negatively change the chemical composition of the water. This also causes water pollution and it affects all ecosystems existing in and around water, including fish and other animals that drink the polluted water. Hazardous household waste items such as batteries, computer equipment and leftover paints can be particularly dangerous for water reservoirs used for drinking water.

According to the World Health Organization, or WHO and the Centers for Disease Control or CDC, mismanaged garbage waste is one of the main causes of health and environmental issues; overflowing garbage is a public nuisance and eyesore. Everyone wants to live and visit places that are fresh, clean and healthy. A smelly city with poor sanitation and trash all over the place does not attract people or tourists, let alone investments. Cities keep losing money, and they also miss out on the revenue and job opportunities coming from proper waste control and recycling.

It is desirable to ensure that every person contributes to keeping their community clean and sanitary through proper contributions to waste management and recycling. More than 75% of all waste is recyclable yet societies only contribute approximately 30%.

The proposed art herein utilizes a reward based system which identifies two main focus elements necessary for a user to desire to participate in said Methods of Recyclable Electronic Coin Based Reward System for Invoking Proper Recycling Procedures. These procedures are derived from monitoring current participants as well as participant habits and the proposed art will identify the main elements involved to ensure proper procedures are met to participate in the Recyclable Electronic Coin Based Reward system but first in this background we will identify key components of the current art and why improvement upon said art is necessary to increase volume of participants as well as expedite an improvement upon our environment. It is believed the proposed art will assist in improving the rapidity of environmental cleanup as well as reward those who participate in said environmental cleanup.

Conventional recycling reward systems simply pay for the value and commodity of said collected recyclable goods from what the market will bear. For this reason the meager reward offered deters participants from utilizing the current recycling system. A participant may spend many hours separating recyclable materials and discard said materials into proper recycle bins without reward while others who do not participate in recycling may place discarded materials into improper disposal dispensers thus causing more work and diluting the practicality of recycling discarded waste materials. Each recycle bin does not know who discards waste nor does it identify proper waste associated with the user who discarded said recyclable waste.

The current recycling system is comprised of a discarding station of perspective recyclable waste materials which becomes a collection station for recycling companies to collect recycled discarded waste material where it is further separated to ensure proper recyclable goods are in their proper genre of waste materials. Once the separation is complete, the recycler company then sends the recycled goods to their perspective recyclable material re-integration facilities where the material is converted into raw material where goods and products are made from said discarded recyclable material. Most companies don't reward the recycler due to the low profit margins associated with low value recycled goods.

Now you can compare the current art by understanding that a user recyclable collecting participant is not very well compensated for their participation which can be a lot of work or effort. For this reason few participate in recycling recyclable goods. There is therefore a need to create a reward based system which ensures first user participation, ensures first user participants follow proper recycling procedures and ensures first user is properly rewarded or compensated for their participation in recycling recyclable goods and materials.

It will become apparent in this application that sufficient description has been given and other modifications could be made without departing from the scope or spirit of the art.

### SUMMARY OF THE INVENTION

A need therefore exists to improve human behavior to be conducive to recycling by creating an intelligent social network connected to mobile applications assisting collection and disposal and reward of recycling materials by both recycler and recycling collector to improve proper management of waste creating a cleaner more economically prosperous society.

The Methods of Improving Recycling Through Human Behavioral Modification is comprised of 21 means, namely; a means for waste collection station consisting of a secured housing containing singular or plurality of identifiable waste bins, a means to identify a social networked recycling participant through an intelligent interactive digital user interface, a means to identify specific genre′ of waste being discarded by said social networked recycling participant, a means to separate discarded recyclable waste, a means to grant access to discard waste of specified selected genre′ of waste into respective selected bin by recycling participant, a means to weigh deposited material, a means for tamper proof of individual bin enclosure with authorized access to recyclable materials by recycling collectors, a method to collect waste genre′ deposit data, a means to display said collected waste genre′ deposited material data on a user interface for tracking purposes, a means to display geo location of each intelligent waste collection station, a means to track individual recycling participant's contributions to a social network of recycling medium, a means to reward each recycling participant equal compensation for their recycling contributions, a means to display and associate said recycling participant's contributions to said social network for other recycling participants to monitor, a means to identify each genre′ of recyclable waste bin being full and geo locating said genre′ of a plurality of recyclable materials to a mobile application providing efficient routing for specific genre′ of recycled waste, a means to identify any intelligent recycling collection station hardware errors and relaying said recycling errors to a mobile app displaying said error and geo location of said error, a means to display efficient routing and tracking of recyclable collector utilizing an online tracking application, a means for compensating recyclable collector for their collection of recyclable waste equal and respective of their volume and weight of waste collected, a means to enhance value or recyclable goods and materials to make recycling more beneficial, a means to track first use performance utilizing a Recyclable Electronic currency wallet, a means for first user to further benefit financially from collecting reward Recyclable Electronic currency within said wallet, a means for identifying said collections receptacles to belong to a first user purchaser for the purpose of controlling reward based system and a means to combine the aforementioned elements to generate an intelligent system which create feedback data to alter or modify each participant's behavior to be more conducive to a more efficient recycling management.

A means for waste collection station consisting of a secured housing containing singular or plurality of identifiable waste bins is comprised of a housing element which houses sufficient electronic hardware for managing discarded materials into respective said identifiable recyclable waste bins and recyclable waste management containers with individual access to each said waste management container as identified by a recycling participant hereinafter known as a first (1^{st}) user. Whereby first (1^{st}) user is part of a social networking group which identifies, monitors and tracks said first user's participation. Said collection station may contain a singular discarding bin for a specific genre′ of recyclable waste or may contain a plurality of discarding recycle bins whereby said first user deposits recyclable waste which is pre-sorted in individual identifiable waste containers.

The waste collection station may be stationary or part of an existing structure which houses said waste bin/s. Said sufficient electronic hardware for managing discarded materials may be electronic control mechanisms confined within said waste collection station which act as a means to sort/divert specific selected genre′ of recyclable waste into respective bin/s contained within said recyclable waste collection station.

A means to identify a social networked recycling participant through an intelligent interactive digital user interface is comprised of creating electronic credentials of said first (1^{st}) user for a social media account generated by said participating first (1^{st}) user who wish to track their recycling progress, share with others their stories of participation or keep private their participation and simply use the social media account to monitor their individual progress in improving recyclable waste management. The Social Media account for the participant may contain images, participation data including weight, genre′ of recyclable materials recycled by said first (1^{st}) user, locations of said discarded recyclable materials, comments on said first (1^{st}) user experience of contributing to recyclable waste management as well as comments by observer hereinafter referred to as first (1^{st}) Alternate user within said social network grading experience and further commenting by said s first (1^{st}) Alternate user of said first (1^{st}) user's stories, contributions, status or compensatory rewards.

Said Social Networked recycling participant first (1^{st}) user's Identity established through biometrics, State or Local ID and may contain first (1^{st}) user's personal information including first (1^{st}) user's e-mail, e-Wallet, i-Wallet, banking info, physical address, contact phone, state, city, country which is verified prior to creation and approval of account access to said first (1^{st}) user. Identity of said first (1^{st}) user is important to establish to give proper compensation to said first (1^{st}) user for said first (1^{st}) user's verified participation of recyclable waste management improvement. Elements of establishing first (1^{st}) user's ID will become apparent further in this application.

A means to identify specific genre′ of waste being discarded by said social networked recycling participant first (1^{st}) user is comprised of a recyclable color coded flexible plastic or carbon based containers containing or embedded with sufficient electronic ID components which digitally identify said recyclable color coded flexible plastic containers as containing the contents of recyclable genre′ respective to the said recyclable color coded flexible plastic or carbon based container assignment. Said assignment associated with registration of said recyclable color coded flexible plastic or carbon based container belonging to said registered and verified account of said first (1^{st}) user. Said sufficient electronic ID may utilize Radio Frequency Identification (RFID), QR Code, UPC Label or Near Field Communication device (NFC) which may be scanned at said waste collection station and associated data collection from said waste collection station weight, genre′, time/date, account name transferred to said first (1^{st}) user's social media account whereby an automated compensatory element is applied along with social media ratings of said first (1^{st}) user reflect said first (1^{st}) user's recyclable waste management efforts. Understanding the relationship between said first (1^{st}) user and said first (1^{st}) user's participation due to said compensatory elements and social media ratings rewards viewed by first (1^{st}) user Alternate will act as components in altering the behavior of said first (1^{st}) user to be more conducive to improving their participation to recyclable waste management. This will be discussed further in this document in the methods of preferred embodiments.

A further element of a means to identify specific genre′ of waste being discarded by said social networked recycling participant first (1^{st}) user is a second level security and is comprised of a sensor identification for raw materials which scans each deposited container prior to releasing said recyclable material into each bin. If the material is found to be proper discarded recyclable material, the deposited material is released into the proper bin however if the material is found not to be the same material as the first user declares, the material is rejected and notification for reselection is made. This can easily be done with transducer echo radar, Laser Maldi Scan or TMDI laser sensors placed in the primary discarding tube which send incoming known particle energy into the contents of the discarded recyclable material. Each material has a density mass which can be identified by the echo due to the fact that part of the energy of the incident particle or wave is absorbed which is then converted into a readable kinetic energy. So once the transducer sends a known value into a container, the echo pings back a different signal which is minus the energy that was absorbed. Each container of paper, plastic, glass or metal will return a different signal thereby allowing a system to record and compare input output signals of each material to be unique This proposed method can ensure the integrity of deposited recyclable material.

Said first user discards recyclable waste in a container which can be identified through scanning devices sufficient to record weight, material type and proper disposal herein and are known as a third level security. Each deposit must be individually identified to belong to the first user who carries a first level security (Initial ID Validation from Social Media Account Generation) and placed in the proper bin. This is important because a person may place items of no value in a bin and the reward weighed and given to said first person. An example of this might be rocks in the aluminum cans. In order to prevent a person from cheating, each container must identify the discarded recyclable material as the proper selection and to ensure the integrity of the recyclable material, one must associate each deposit with the participating user. In this application we propose RFID infused bags whereby each bag is infused with an RFID chip. Each chip is associated with the dispenser which is registered to each first user. There are two proposed ways to ensure proper identification of each deposit belonging to each first user; 1.) Each person must register individually dispensed bags at each recycling deposit location whereby each bag is color coded and RFID infused. First person places biometric ID to ensure proper reward goes to first user upon correct deposit of recyclable materials. This would require each recycling location to distribute RFID infused color coded bags to the first user upon proper ID registry. Once the first user has made a deposit into the bin, the bin contains sufficient sensors to ensure proper recyclable material is present in said first user's deposit. The recyclable material discarded by the first user is then weighed and reward is exchanged in the form of a Recyclable Electronic currency or existing on a block chain. 2.) First user purchases in bulk a package (Will be listed in the drawings and in the claims further down in this application) whereby said first user must register package either by scan of QR code or Bar Code scan which in turn registers said package of recyclable bags to said first user.

Usage of said bags now is registered to first user and a third level security is generated when deposits are made at the recycling facility and the registered bag deposit will reward the proper first user upon proper biometric ID first level security. The discarded recyclable material is weighed and a reward for each deposit is associated with said first user utilizing first level security who followed proper recycling procedures or following a third level security. However if at a later time a bag is found to be null, the deposit is removed from the system and reward retracted and said second level security identifies improper recycling procedures by said first user with first level security. A notification service will then notify first user of breech of user responsibility and suspend their account upon further investigation. It is therefore proposed a time frame between reward given and actual reward have a period of verification until such time the user is deemed reliable.

A means to separate discarded recyclable waste is comprised of a sorting device hereinafter known as a “diverter”. Said diverter containing sufficient components to alter the path of specific pre-selected recyclable waste into a respective bin. Said first (1^{st}) user engages an electronic human user interface which identifies and verifies said first (1^{st}) user allowing all information of said first (1^{st}) user's transaction to be associated with said first (1^{st}) user's contributions. Sufficient electronic and mechanical hardware within said waste collection station alters the path of said recyclable waste by diverting it in a respective path so said specific genre′ of recyclable waste is deposited in the proper respective bin as pre-selected by said first (1^{st}) user. Said diverter mechanism may include a rotating strike plate at the base of a garbage chute or an actuated strike plate located over or above said respective bin which actuates when specific genre material arrives in the vicinity of said specific genre′ waste recycling bin.

A means to grant access to discard waste of specified selected genre′ of waste into respective selected bin by said first (1^{st}) user is comprised of sufficient electromechanical hardware which initially locks all access to all discarding portals of each respective genre′ of recyclable waste bins until said first (1^{st}) user is properly identified by said electronic credentials which may include but not limited to Pin Code Entry, QR Code Mobile App Scan or Biometrics which grant further access to said selection profile. Said electronically verified first (1^{st}) user makes a genre′ selection of recyclable waste they wish to discard. The said waste collection station containing sufficient electronic and mechanical hardware controls the electro mechanical access to a waste portal located over an associated singular or plurality of recyclable material bin. The said electromechanical device prompts said first (1^{st}) user to open an access device granting a portal to the respective selected recyclable waste bin. After said first (1^{st}) user discards recyclable materials, the weight, time/date and genre′ are recorded and uploaded to a web service to said first (1^{st}) user's verified social media account.

A means to weigh deposited material by a said first (1^{st}) user is comprised of a scale located at the base of said bin which measures an accurate or approximate weight of said discarded recyclable material by said first (1^{st}) user. Said scale only takes reading change difference between initial weight (Tare Weight first (1^{st}) reading) and deposited recyclable material waste weight second (2^{nd}) reading. Said difference of first (1^{st}) reading and second (2^{nd}) reading is recorded as final reading of weight discarded by said first user. This said reading is logged into a digital storage medium and associated in the social media account of said first (1^{st}) user displayed in said social media account and data used for associating said first (1^{st}) user's contribution efforts to proper recycling waste management.

Each reading of the individual deposits is recorded and the bin weight reset to tare. The stored individual recorded weights are combined to give a total of the recycling contribution over time/date respective of the first (1^{st}) user's efforts in proper recycling waste management.

A means for tamper proof of individual bin enclosure with authorized access to recyclable materials by recycling collectors hereinafter referred to as second (2^{nd}) user is comprised of an access system that secures said bin from first (1^{st}) user to prevent any unauthorized access to recyclable waste materials. By creating a tamper proof access allowing a second (2^{nd}) user only, the recycling enclosure prevents re-inserting already discarded material back into the system by collecting said recyclable material from recycle bin and placing same genre′ of recyclable waste back in said bin thereby giving credit for said recyclable waste more than once to the same first (1^{st}) user.

A method to collect waste genre′ deposit data is comprised of three (3) basic elements. 1.) Bin capacity sensor and 2.) Weight scale located under said genre′ of recycle bin, 3.) Sufficient processing web accessible computing hardware to report said weight, bin capacity, first (1^{st}) user ID, time/date and deposit genre′ of recyclable waste being discarded.

All said data collected is uploaded to a central web based server which stores information for conversion to a graphical user interface (GUI) to be viewed by first (1^{st}) user and first (1^{st}) user alternates within the said social media network.

All said data collected further comprised of Bayesian protocol modeling to provide feedback loop strategies of changing behavior of recycling participants by monitoring action vs reaction within said social media network and applying behavior improvement models to said recycling improvement system.

A means to display said collected waste genre′ deposited material data on a user interface for tracking purposes is comprised of data collection and stored data in a database, DAT file or other storage mediums and applying graphic user interface (GUI) modeling software to convert said data into graphic models for public and private viewing of said data in an easy to understand interface.

A means to display geo location of each intelligent recycling waste collection station is comprised of an online map service which provides pin drop locations of said waste collection stations which have been registered to belong to a specific second (2^{nd}) party financial compensation provider. While competition of second (2^{nd}) party financial compensation providers will drive the prices up thereby increasing rewards given to first (1^{st}) party users. Each pin drop may be ironically represented to each second (2^{nd}) party financial compensation provider giving each first (1^{st}) user a choice of which recycling waste collection station they wish to use. By centralizing the compensation reward through a social media network, you provide each of the second (2^{nd}) party financial compensation providers with first (1^{st}) user recyclers and also provide all first (1^{st}) users with a plethora of second (2^{nd}) party financial compensation providers to choose from.

A method to track individual recycling participant's contributions to recycling is comprised of a first ease of recycling collection and separation in and around their residential establishments, a second easy access intelligent recycling waste management facility to distribute said collected recyclable materials by said social media account verified first (1^{st}) users, reporting said first user's recycling efforts, experience, geo-location, ecological impact and compensation to said social media accounts which can be monitored in both private and public mode whereby said first (1^{st}) user may share stories of their recycling efforts with other first (1^{st}) user alternates and inspire said first (1^{st}) user alternates to improve their efforts in proper recycling waste management thereby improving the global ecology.

A means of providing social network of recycling medium is comprised of creating a user account to record a first (1^{st}) user's participation in a social media platform whereby said social media platform contains verified first (1^{st}) user information, second (2^{nd}) user collector information and second (2^{nd}) user financial contribution provider information to provide data of recycling materials, collection time/date, weight, genre′ of recyclable waste and geo-location of said recyclable waste.

Other elements of said social media network may contain personal and financial compensation viewed in any combination of private and public mode. All data collected to be utilized to improve recycling strategies of said first (1^{st}) user through Bayesian protocol applications.

A means to reward each recycling participant equal compensation for their recycling contributions is to reward said first user for following proper recycling procedures is comprised of a Recyclable Electronic currency transfer of Recyclable Electronic funds from a Second Compensation Provider account to said first user utilizing first level security wherein said first user compensation upon proper discarding of recyclable materials. A fourth (4^{th}) user representing the purchaser of recyclable goods in ownership of recycling materials collection stations utilizes the first 3 aforementioned security measures; a means to identify a social networked recycling participant through an intelligent interactive digital user interface, a means to identify specific genre′ of waste being discarded by said social networked recycling participant and materials or second level security measure and a means to associate said deposited recyclable goods with first user to ensure proper reward is received by said first user being a third level of security measure. Second Compensation Provider collects recyclable goods and distributes them at a profit to companies who convert the recyclable goods to raw materials used to make recycled products and assist in cleanup of the earth's environment.

A Recyclable Electronic wallet is an account held by the first user which said Second Compensation Provider participant transfers money equal to the value of the discarded material discarded by said first user. Said discarded material is weighed, identified as proper genre of recyclable goods and said first user properly identified prior to release of funds into the Recyclable Electronic Wallet. Recyclable Electronic currency is held in a block chain to ensure proper integrity and security of available funds representing reward for discarded material discarded by said first user. The value of discarded recyclable goods is to be determined later in this proposed application.

A means to display and associate said recycling participant's contributions to said social network for other recycling participants to monitor is comprised of a data collection of each said first (1^{st}) user recycling participation and generating graphics associated with said first (1^{st}) user recycling efforts. This graphic generation will include volume of participation, recycling habits, noteworthy actions of recycling efforts and geo-location of recycling efforts as well as environmental impact of said recycling efforts of said first (1^{st}) user.

A means to identify each genre′ of recyclable waste bin being full and geo locating said genre′ of a plurality of recyclable materials to a mobile application providing efficient routing for specific genre′ of recycled waste is comprised of a registration system which registers location of waste management facilities, the said waste management facilities containing information such as fill volume of each recycling container or bin, usage data, time/date or event errors. These event errors may include hardware failure, fire or excess moisture, PPM (Parts Per Million) of airborne contaminates and power consumption of said recycling facility.

The said geo-location can be separated in Google Maps or other GPS programs which offer pin drop location and menu based navigation. Each pin drop identifying paper %, plastic %, metal %, glass %, cardboard %, electronic %, medical waste %, battery %, organic waste % or general waste %.

A means to identify any intelligent recycling collection station hardware errors and relaying said recycling errors to a mobile app displaying said error and geo location of said error is comprised of sensors which are in and around said recycling facility for the purpose of managing recyclable goods security. Each sensor is respective of operation according to the need of monitoring and reporting any errors within said recyclable containers. Each respective sensor creates threshold data and is recorded into a data model. This data model is used to generate graphic representation of volume, weight, genre′ and geo-location of recyclable waste.

Said data thresholds of data models have preset values which trigger “alarm events” which automatically identify by icon representing said error code associated with exceeded threshold data collection.

A means to display efficient routing and tracking of recyclable collector utilizing an online tracking application is comprised of a collector registration, verified participant in said recycling management and geo-locating hardware which identifies app geo-location on a mobile platform which collect data from the recycling waste collector smartphone GPS, accelerometer, and gyroscope.

After the recycling route is completed the drivers are sent post-trip amortization that show things like how many times they stopped and location of each stop, time of each stop and amount collected of a specific genre′ of recyclable waste at each stop.

The data collection could be useful for the recyclable waste collector to assist in future strategic routing and improved collection times at each stop. Every byte of data is collected and sent to a central location server where recyclable driver data is stored. The data is stored long-term, and can be used for other services. The stored data could be used for is the daily city level average traffic flow to learn when best times of recyclable waste collection should be done.

A means for compensating recyclable collector for their collection of recyclable waste equal and respective of their volume and weight of waste collected is comprised of a multi-tier compensation application utilizing Bayesian protocols to assist in generating a self-improving strategy that ensures each first (1^{st}) user improves their participation in recycling recyclable waste. These compensations elements include monetary compensation, social status compensation and recognition of efforts compensation and even trade of goods for efforts applied by said recycling first (1^{st}) user recycling contributions. We discuss further enhancements of compensation using crypto currency and electronic wallets.

A means to enhance value or recyclable goods and materials to make recycling more beneficial to said first user is created by a fourth user participant who supports both environmental cleanup for tax incentives as well as participation of conversion of currency between the Recyclable Electronic wallet and first user and it is understood a vendor who accepts said Recyclable Electronic currency for goods or services, hereinafter known as fourth user participant may also contribute as well to the value of acceptance of said recyclable Electronic Coin based currency. By increasing the value of the commodity of recyclable goods as a raw material and collaborating environmental impact and fourth user participants rewarding said Recyclable Electronic Currency the value of said first user participation in the proper procedure of recycling increases 3 fold. Therefore the value of recycling now becomes of a value acceptable to increase participation rate of recycling recyclable materials.

First user generates a first level security credentials and creates proper identification using biometrics before becoming a participant for recycling recyclable materials. First user with first level security utilizes proper recycling containers with second level security to deposit recycling goods into Second Compensation Provider participant's recycling collection stations. Second Compensation Provider enhances first user rewards by seeking funds from third users who are connected with environmental impact and wish to assist in cleaning up the environment as well as convincing other fourth user participants in accepting Recycling Electronic Currency giving discounts to those who choose to use said Recycling Electronic Currency as a further reward of their efforts in proper recycling.

A means to track first use performance utilizing a Recyclable Electronic currency wallet utilizes a block chain which is a shared public ledger on which the entire Electronic Coin network relies. All confirmed transactions generated by a first user to a fourth user participant are included in the block chain. It allows the Electronic Coin wallets to calculate the first user's spendable balance so that new transactions can be verified thereby ensuring they're actually owned by the first user. The idea of decentralization of Electronic Currency is by design, the block chain being used in a decentralized technology. In this application we use a global network of computers use block chain technology to jointly manage a database that records Electronic Currency transactions. That is, Electronic Currency is managed by its network, and not any one central authority. A block chain is the structure of data that represents a financial ledger entry, or a record of a transaction. Each transaction is digitally signed to ensure its authenticity and that no one tampers with it, so the ledger itself and the existing transactions within it are assumed to be of high integrity.

By utilizing first users physical work converted to Electronic based currency, mining of Electronic currency becomes a joint venture between the reward ledger transferred rewards to the first user recycler account by said Second Compensation Provider recycled goods purchaser. Each transaction is stored much in the same way as the block chain technology whereby said first user physical efforts translate to financial reward given by said Second Compensation Provider and modified by a third user who participates in environmental cleanup finally to be taken by a fourth user participant who offers goods and services by accepting Recycling Electronic Currency of the said first user.

A means for first user to further benefit financially from collecting reward Recyclable Electronic currency within said wallet is the combination of multiple organizations contributing to the cause of recyclable materials being collected to drive the value of each genre of recyclable goods, plastic, paper, metal and glass and other common recyclable goods. If plastic bottles are only worth 0.07 cents per pound and multiple participants who wish to see plastic cleaned up from the environment may wish to participate in a tax deductible donation to the second party which enhances the value of the plastic recyclable goods to 0.50 cents per pound thereby enhancing the reward given for said recyclable material from Second Compensation Provider purchaser to first user collector. The same model for paper, aluminum and glass and other common recyclable goods can be applied to enhance the value for first user participants following proper recycling procedures.

A means for identifying said collections receptacles to belong to a first user purchaser for the purpose of controlling reward based system is comprised of a registration system whereby said first user generates first user account thereby generating a reward receiving Electronic wallet with a “$0” or primary state. (It is recognized that anyone skilled in the art of Electronic currency reward based systems could further enhance reward based system by increasing the value of the primary state upon account creation.) Once account is created by said first user to properly identify said first user Electronic reward blockchain, a registration of a secondary container which identifies ownership of said first user. It is the belief of this proposal that each first user participant is more likely to follow proper recycling procedures if they know their deposits are tracked for ownership.

User inputs to a database field record user information and biometrics whereby said first user participants who follow proper recycling procedures can be rewarded for their proper recycling efforts. However if a first user fails to follow proper recycling procedures, their account can be suspended upon further investigation of mistakes being made which falsely identify proper recycling procedures. In this application we propose a learning system such as Artificial Neural Network and Bayesian protocols which learn each first user recycling habits to be parallel with said proper recycling procedures. Said learning system will at first have a waiting period between rewards being distributed and over time adapt to each first user participant upon identifying a trend of proper recycling protocols being followed.

A means to combine the aforementioned elements to generate an intelligent system which create feedback data to alter or modify each participant's behavior to be more conducive to a more efficient recycling management is comprised of combining Social Media accounts for a verified first (1^{st}) user recycling participant with elements of electronically enhanced recycling management centers which monitor and report said first (1^{st}) user's participation, second (2^{nd}) user collection efforts and digital reporting of recyclable waste genre′ within each said recycling facility. Providing elements of easing recycling for said first (1^{st}) user and discarding stations which track and report first (1^{st}) user transactions and monitoring said first (1^{st}) user experiences on said first (1^{st}) user's social media verified account through a data collection protocol. This said data collection protocol utilizes the monetary reward compensation, social status and experience publications to alter or improve the general recycling of the overall proposed system.

User interfaces providing graphs, data, ratings, monetary compensation, comments of other first (1^{st}) user alternates who provide feedback of user experiences as well as geo-locations of each effort will be used to determine environmental, economic and general health improvements of each society, area of effect and global impact.

### DESCRIPTION OF DRAWINGS

FIG. 1 is a first collection container shown with biometric collection hardware, MCU, CPU, sufficient hardware to identify recyclable material collection genre as well as distribution of secondary containers used for deposit by said first user which properly identify said secondary containers to belong to said first user upon deposit thereby properly identifying said first user deposit being made by said first user in Second Compensation Provider's collection bin.

FIG. 2 shows a first security measure of biometrics which identifies facial recognition of the first user registering agent whereby said biometric identification is registered to a web interface which properly identifies each first user participant participating in proper recycling procedures.

FIG. 3 shows a second security measure of biometrics which utilizes fingerprint identification of the first user registering agent whereby said biometric identification is registered to a web interface which properly identifies each first user participant participating in proper recycling procedures.

FIG. 4 shows a recycling Electronic block chain with states of first user recycler and Second Compensation Provider recycling collector whereby first state of said blockchain shows transactions between each state. Each state of each transaction is either “stored”, in “state root” or “transaction” state determined by transactions between first user recycler, (Reward transferred from Second Compensation Provider and received by first user for following proper recycling procedures), Second Compensation Provider collector, (Reward transaction collected by first user for following proper recycling procedures, from Second Compensation Provider who collects residual market value plus secondary monetization of recyclable goods at a residual value increased by said third user participant environmental impact promoter and between fourth user participant who further increases the transaction state value by offering further reward benefits for utilizing said recycling Electronic currency from first user).

FIG. 4a shows Second Compensation Provider giving first user participant 10$ which changes the state by executing a transaction on it. This keeps track of the balances and other details of different users (states) and the details of what happens between said first user and Second Compensation Provider on the blockchain or (transactions).

FIG. 5 shows a block diagram of a plurality of recycling participants beginning with a first user who generates a user account and becomes a verified participant who provides a proper procedure of recycling recyclable goods, a Second Compensation Provider who collects further monetary value of recyclable goods by finding third user participants who wish to participate for personal and taxable gains in environmental cleanup and recycling where said first user benefits from the increased value generated by Second Compensation Provider collection participants and finally a fourth user who provides goods and services extending value by offering an increased value of recyclable Electronic currency.

FIG. 6 is a collection container which can be provided by said Second Compensation Provider participant or purchased at a recyclable material collection distribution center whereby said collection container begins as a flat box and is folded into a triangle. Within the confines of said collection container is a second collection container containing plastic bags. Said primary foldable container utilizes barcode or QR codes so each first user participant who obtains said foldable container can register internally held recycling containers, each one with embedded solution to properly identify said secondary containers to belong to said first user registered recycling agent.

FIG. 7 is a plurality of first collection containers shown with biometric collection hardware located 15 of FIG. 7 on Kiosk, MCU, CPU, sufficient hardware to identify recyclable material collection genre in each container as well as distribution of secondary containers used for deposit by said first user which properly identify said secondary containers to belong to said first user upon deposit thereby properly identifying said first user deposit being made by said first user in Second Compensation Provider's plurality of collection bins located on a platform 11 FIG. 7 containing a scale on each container to measure deposit by said first user.

FIG. 8 is a plurality of first collection containers (500A, 500B & 500C Respectively) shown with underground collection bins (501A, 501B, 501C Respectively) with a Kiosk 510, which collects first user information for verification purposes. Located below the raising platform is sufficient hardware to raise and lower each collection bin (501A, 501B & 501C Respectively) to empty recyclable material upon collection by a recyclable collection personnel.

FIG. 9 is a flow chart showing a waste sorting device located within Station A and Station B where Station A is an existing enclosed structure such as high rise building or single unit complex and Station B is a portable structure with secure access for first (1^{st}) user recycling deposits and secure access for second (2^{nd}) user access to bins to empty, track and update a network between flow of recyclable goods to a logistics center before being taken to a recycling facility. All aforementioned participants and structures of bin containment as well as weight and volume is uploaded electronically to a cloud server on a network. This data is supplied to Building Owners, tenants or other users utilizing the recycling system through a mobile application. This information is then formatted in such a way to graphically display information of geo-location of recycling waste management facilities for public access, for collectors and for waste collection companies. Said waste collection companies may utilize a sorting and data generation agent to update, verify and sort said recyclable waste.

FIG. 10 is a line graph showing a learning process from applied events such as Social Media promotion of recycling individual, compensatory actions financially rewarding said first (1^{st}) user equal to their recycling waste participation and promotion of actions and events which improve recycling participation rates among registered first (1^{st}) users. A Bayesian protocol is applied learning of past events and utilized to stimulate participation of first (1^{st}) users to improve their recycling participation percentage. Whereby each step of improvement and applied learning is utilized to improve the said percentage of participation in recycling waste management.

FIG. 11 is a recycling management structure containing separate genre′ of bins with secured hardware authorized electronic access and geo-locating hardware, bin capacity fill sensors and user access portals.

### DETAILED DESCRIPTION

List of Major Components

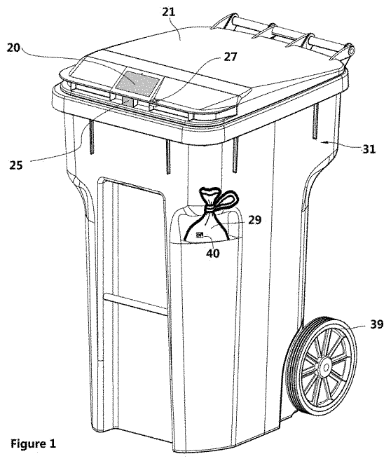

FIG. 1 Shows a first collection container (31) shown with biometric collection hardware (27), MCU, CPU, sufficient hardware (20) to identify recyclable material collection genre (Not Shown) as well as distribution of secondary containers (29) used for deposit by said first user which properly identify said secondary containers utilizing a RFID, Barcode or QR code (40) to belong to said first user upon deposit thereby properly identifying said first user deposit being made by said first user in Second Compensation Provider's collection bin (31). First user is properly identified by a biometric reader (27) which identifies said first user making recyclable material deposit into recycle bin (31). A lock (25) which controls the lid entry system (21) prevents the unauthorized access by other non-participants. Said recycling bin is only used for each recycling deposit genre such as “Glass, Paper, Plastic or Metal” and in this proposal said collection bin (31) may be mobile to allow said Second Compensation Provider to roll said bin (31) with sufficient mechanisms which assist in ease of mobility (39) to allow other participants in the collection of recyclable goods to remove contents in said bin (31).

Further embodiments of this proposal contain a distribution of identifiable containers (29) located in a distribution chamber located in or around said recyclable bin (31) whereby said distribution chamber identifies a secondary container containing sufficient identifiable mechanisms that associate said deposit with proper identification of contents and proper identification of said first user recycling participant. Also not shown in figure one is a weight mechanism which identifies the weight of said recyclable material deposit by said first user so as to identify the amount of said deposit to equate to reward provided by said Second Compensation Provider recyclable material collector.

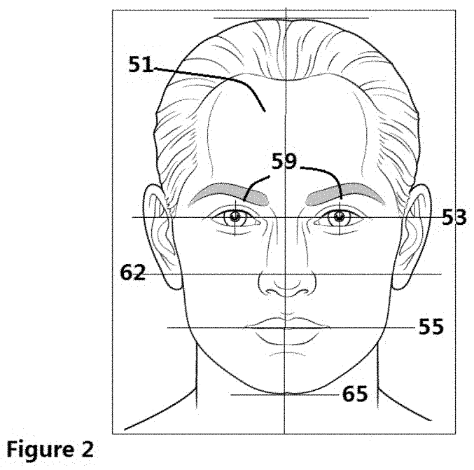

FIG. 2 shows a first security measure of biometrics which identifies facial recognition of the first user registering agent whereby said biometric identification is registered to a web interface which properly identifies each first user participant participating in proper recycling procedures. A value of first user's image diagnostics, storage and retrieval system identifies unique measurements of the forehead (51), distance between the eyes (59) as well as the relation between the eyes (53), nose (62) and mouth (55). Once the identification markers (51, 59, 53, 62, 55 and 65) relationships are identified, a biometric mathematical model is stored in a database (Not Shown) corresponding said measurements to said first user for instant recognition which allows proper compensation to be given to said first user registered agent.

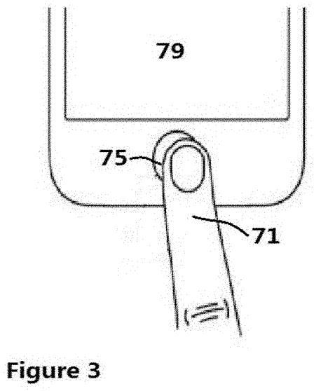

FIG. 3 shows a second security measure of biometrics which utilizes fingerprint identification (75) of the first user registering agent whereby said biometric identification is registered to a web interface (79) which properly identifies each first user participant participating in proper recycling procedures. Said first user downloads a Graphical user interface to said mobile device (79) and generates an account by registering biometric fingerprint (75) by placing a finger (71) onto a fingerprint scanner (75) where said fingerprint of first user is recorded and a biometric mathematical model is stored in a database (Not Shown) corresponding said measurements to said first user for instant recognition which allows proper compensation to be given to said first user registered agent.

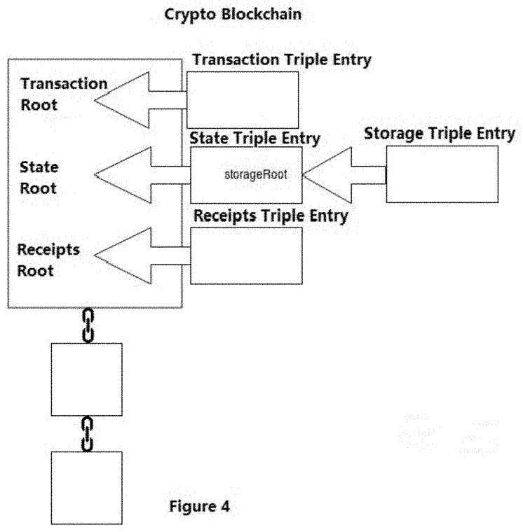

FIG. 4 shows in one embodiment of Electronic currency the world state is able to manage account balances, which is similar to Ethereum. The state of Electronic currency is not an abstract concept. It is similar to Ethereum base layer protocol. Similar to Ethereum, the Recyclable Electronic currency is a transaction-based “state” machine; a technology on which all transaction based state machine concepts may be built. As with all other blockchains, the Recyclable Electronic Currency model blockchain begins life at its own genesis block. From this point (genesis state at block 0) onward, activities such as transactions, contracts and mining will continually change the state of the Recyclable Electronic Currency blockchain. In Recyclable Electronic Currency an example of this would be an account balance (stored in the state trie or Triple Entry) which changes every time a transaction, in relation to the first user account, takes place.

Data such as account balances are not stored directly in the blocks of the Recyclable Electronic Currency blockchain. Only the root node hashes of the transaction triple entry, state triple entry and receipts triple entries are stored directly in the blockchain. As illustrated in the FIG. 4 diagram. From the diagram in FIG. 4, the root node hash of the storage triple entry or Trie (where all of the smart contract data is kept) actually points to the state Trie which in turn points to the blockchain. There are two vastly different types of data in Model of FIG. 4 and Model of FIG. 4a; permanent data and ephemeral data. A good example of permanent data would be a transaction. Once a transaction has been fully confirmed, it is recorded in the transaction Trie; it is never altered. An example of ephemeral data would be the balance of a particular Electronic Currency account address. The balance of an account address is stored in the state Trie and is altered whenever transactions against that particular account occur. The permanent data, or mined transactions, and ephemeral data, or account balances, should be stored separately. The proposed Electronic Currency will utilize Trie data structures to manage data.

The record-keeping for the Recyclable Electronic Currency is just like that in a bank. Similarly to using an ATM/debit card. The bank tracks how much money each debit card has, and when we need to spend money, the bank checks its record to make sure we have enough balance before approving the transaction invoked by the first user participating in the Recycling Electronic Currency reward system.

FIG. 4a shows a second embodiment of Electronic Currency usage where a Second Compensation Provider giving first user participant 10$ which changes the state by executing a transaction on it. This keeps track of the balances and other details of different users (states) and the details of what happens between said first user and Second Compensation Provider on the blockchain or (transactions). The Electronic Currency “state” is represented by its global collection of Unspent Transaction Outputs (UTXOs). The transfer of value in Recyclable Electronic Currency is placed into action through transactions. More specifically, a Recyclable Electronic Currency first user can spend one or more of their UTXOs by creating a transaction and adding one or more of their UTXOs as the transaction are input. Firstly, Recyclable Electronic Currency UTXOs cannot be partially spent. If a Recyclable Electronic Currency first user spends 0.5 of the Electronic currency in their wallet (using their only UTXO which is worth 1 Electronic currency coin) they have to deliberately self-address (send themselves) 0.5 Electronic Currency Con in return change. If they don't send themselves change, they will lose the 0.5 of the value of their Electronic change to the Electronic coin miner who mines their transaction or distributes the reward for their physical labor of proper recycling.

The UTXO system in Electronic currencies works well, in part, due to the fact that digital wallets are able to facilitate most of the tasks associated with transactions. Including but not limited to:

a) handling UTXOs

b) storing keys

c) setting transaction fees

d) providing return change addresses

e) aggregating UTXOs (to show available, pending and total balances)

One analogy for the transactions in the UTXO model is paper bills (banknotes). Each account keeps track of how much money it has by adding up the amount of bills (UTXOs) in the purse (associated with this address/wallet). When a first user wants to spend money, said first user use one or more bills (existing UTXOs), enough to cover the cost of a fourth user participant and maybe receive some change back (new UTXO). Each bill can only be spent once since, once spent, the UTXO is removed from the pool.

To summarize:

1.) the Electronic Currency blockchain does not hold account balances

2.) Electronic Currency wallets hold keys to UTXOs

3.) if included in a transaction, an entire UTXO is spent (in some cases partially received back as “change” in the form of a brand new UTXO)

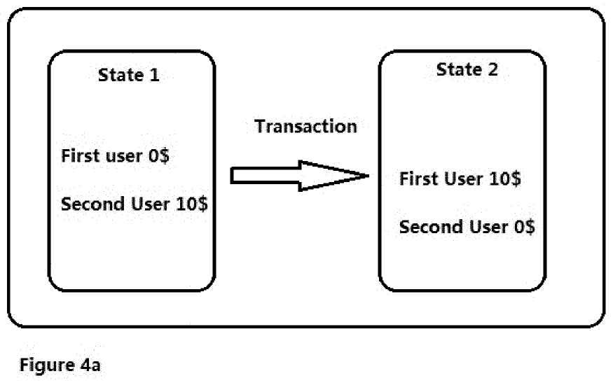

FIG. 5 shows a block diagram of a plurality of recycling participants beginning with a first user who generates a verified first user account which in turn generates a primary state recycling Electronic wallet and said first user becomes a verified participant who provides a proper procedure of recycling recyclable goods to a Second Compensation Provider. Said Second Compensation Provider collects further monetary value of recyclable goods by finding third user participants who donates to the cause of environmental cleanup and wish to participate for personal and taxable gains in said environmental cleanup and recycling. A said first user benefits from the increased value generated by Second Compensation Provider collection participants where residual value of recyclable goods is increased through efforts of Second Compensation Provider participant which increases the participation of proper recycling procedures creating a larger group of first users who collect recycling materials and sell to Second Compensation Provider for an increased amount of Electronic currency reward. A fourth user who provides goods and services who is a participating vendor extends the value of recyclable materials collected by said Second Compensation Provider by offering an increased value of recyclable Electronic currency which increases the goods and services for said recyclable Electronic currency through further donation or offerings by the vendor accepting said recyclable Electronic rewards in the blockchain.

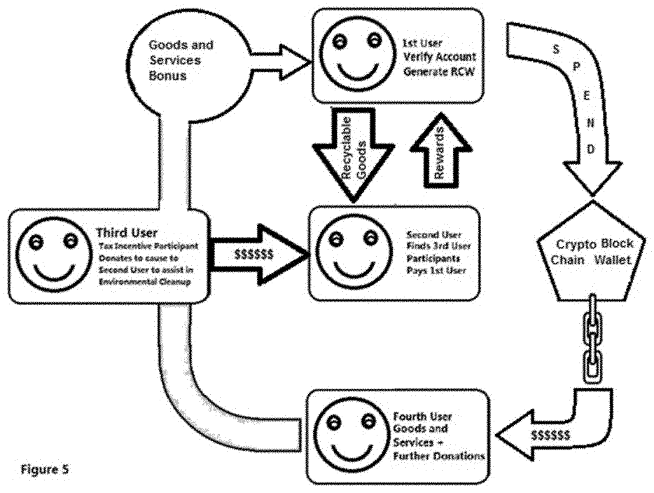

FIG. 6 is a collection container (401) which can be provided by said Second Compensation Provider participant or purchased at a recyclable material collection distribution center whereby said collection container (401) begins as a flat box (step 1 FIG. 6) and is folded into a triangle (Step 2 FIG. 6) Within the confines of said collection container (401) is a second collection container containing plastic bags (411) showing each said plastic bag (411) within primary container (401) is distributed in layers where said secondary plastic containers are contained within each other (Shown in 403 of FIG. 6). Said primary foldable container (401) utilizes barcode or QR codes (420) so each first user participant who obtains said foldable container can register internally held recycling containers (411), each one with embedded solution to properly identify said secondary containers to belong to said first user registered recycling agent.

In a further embodiment of FIG. 6, said secondary containers (411) contain a RFID or Ambient Backscatter device (500) which identifies said secondary container (411) to belong to said first user upon proper registration of barcode or QR code located on the outside of the primary container (401). Each fold of the primary container (401) contains a flap which interlocks with the adjacent corresponding flap (415, 419) respectively. A first user unfolds said primary container (401) and interlocks flaps to each other (415, 409) respectively which forms a triangle which can stand. Inside each primary container (401) is a plurality of secondary containers (411) which are stored together whereby each secondary container (411) is distributed internally of each individual secondary container shown in FIG. 6 (403). After each secondary container (411) is filled, it is removed exposing the next secondary container (411, 403) whose rim is wrapped around the outside of said primary container (step 3 FIG. 6) where said secondary container contains sufficient hardware for Near Field identification of embedded solution providing a means of security and proper identification of possession of said first user registrant.

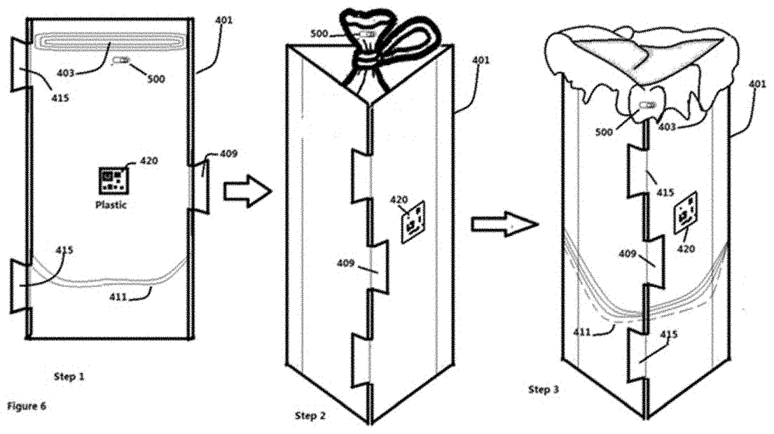

FIG. 7 Shows a plurality of first collection containers (31) shown with biometric collection hardware (17), MCU, CPU, sufficient hardware (20) to identify a plurality of recyclable material collection genres (3 containers) as well as distribution of secondary containers (29) used for deposit by said first user which properly identify said secondary containers utilizing a RFID, Barcode or QR code (40) distributed to said first user through proper identification means allowing said elements of deposit to belong to said first user upon deposit thereby properly identifying said first user deposit being made by said first user in Second Compensation Provider's collection bin (31). First user is properly identified by a biometric reader (17) which identifies said first user making recyclable material deposit into recycle bin (31). A lock (25) which controls the lid entry system (21) prevents the unauthorized access by other non-participants. Said recycling bin is only used for each recycling deposit genre such as “Glass, Paper, Plastic or Metal” and in this proposal said collection bin (31) may be mobile to allow said Second Compensation Provider to roll said bin (31) with sufficient mechanisms which assist in ease of mobility (39 FIG. 1) to allow other participants in the collection of recyclable goods to remove contents in said bin (31).

Further embodiments of this proposal contain a distribution of identifiable containers (29) located in a distribution chamber located in or around said recyclable bin (31) whereby said distribution chamber identifies a secondary container containing sufficient identifiable mechanisms that associate said deposit with proper identification of contents and proper identification of said first user recycling participant. Also not shown in FIG. 7 (seven) is a weight mechanism which identifies the weight of said recyclable material deposit by said first user so as to identify the amount of said deposit to equate to reward provided by said Second Compensation Provider recyclable material collector.

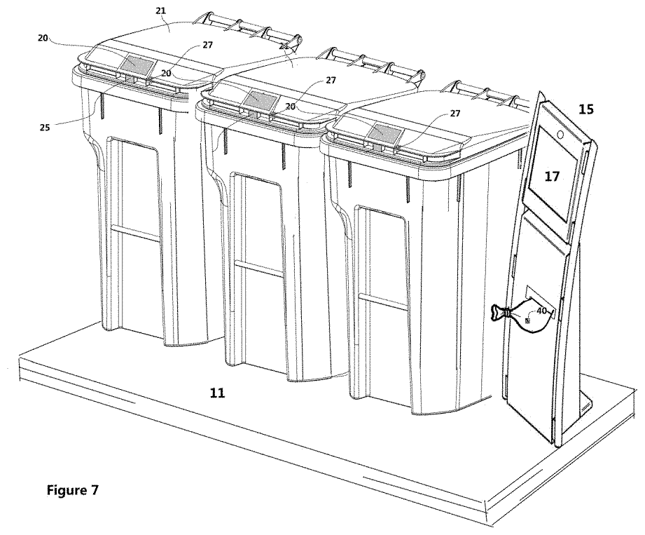

FIG. 8 is a plurality of first collection containers (500A, 500B & 500C Respectively) shown with underground collection bins (501A, 501B, 501C Respectively) with a Kiosk 510, which collects first user information for verification purposes. Similar to FIG. 7 said Kiosk can be equipped with distribution mechanisms which distribute electronically identifiable bags corresponding in color to each country's color code identifying each genre of recyclable materials. Located below the raising platform is sufficient hardware to raise and lower each collection bin (501A, 501B & 501C Respectively) in order to empty said bin when such time the electronic hardware used to identify each collection bin (501A, 501B & 501C Respectively) capacity for notification services. The Kiosk contains a MCU & CPU with sufficient hardware to identify recyclable material collection genre in each container which is unlocked after proper identification bag has been revealed to the sensory hardware located on each discarded material in containers (500A, 500B & 500C Respectively).

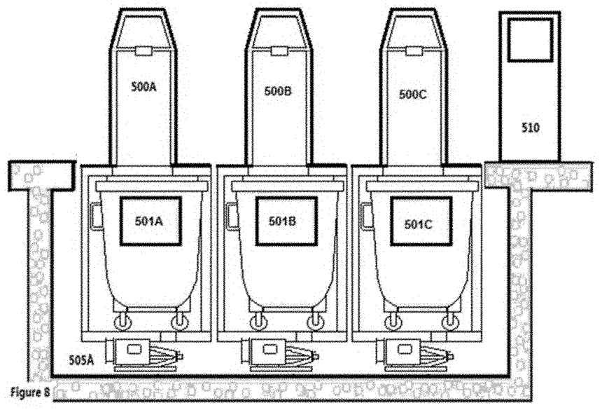

FIG. 9 is a flow chart showing a waste sorting device where said sorting device may contain a rotating strike plant diverting waste into respective pre-selected recycling containers or an actuated strike plate which when activated over the top of a pre-selected respective recycling container thereby diverting said recyclable materials into the pre-selected bin. These diverting mechanism are located within Station A sorting area located within a large high rise which utilized garbage chutes or conveyor system which migrates respective pre-selected recyclable materials to a specific bin associated with the first (1^{st}) user's recyclable waste selection. The Station B is a portable or a fixed structure that has a secure access for first (1^{st}) user discarding recycling deposits and secures access for second (2^{nd}) user collector access to bins which need to be emptied, a system to track and update a cloud based network of in-route progress of said collector moving said recyclable goods to a logistics center before being taken to a recycling facility. All aforementioned participants and structures of bin containment as well as weight and volume are uploaded electronically to a cloud server on a network. This data is supplied to Building Owners, tenants or other users utilizing the recycling system through a mobile application. This information is then formatted in such a way to graphically display information of geo-location of recycling waste management facilities for public access, for collectors and for waste collection companies. Said waste collection companies may utilize a sorting and data generation agent to update, verify and sort said recyclable waste.

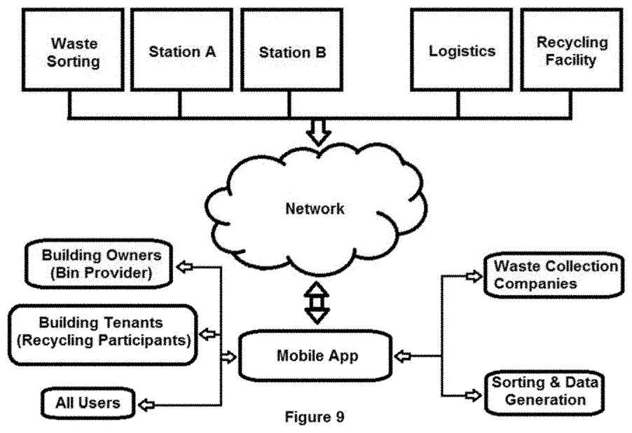

FIG. 10 is a line graph showing a learning process from applied events such as Social Media promotion of recycling individual, compensatory actions financially rewarding said first (1^{st}) user equal to their recycling waste participation and promotion of actions and events which improve recycling participation rates among registered first (1^{st}) users. A Bayesian protocol is applied learning of past events and utilized to stimulate participation of first (1^{st}) users to improve their recycling participation percentage. Whereby each step of improvement and applied learning is utilized to improve the said percentage of participation in recycling waste management. A Bayesian analysis as an alternative approach in analyzing social media data. A Bayesian multilevel model analysis with social media data is used to interpret the results and to generate future recycling strategies. This application uses a dataset regarding recycling behavior, learning and applied strategies which are analyzed to generate new strategies to alter recycling behavior of said first (1^{st}) users. An analysis is performed which offers a network-structured data generated graph model and visualization to diagnose and estimate results and generate future possible strategies to alter recycling behavior of first (1^{st}) user recycling participants.

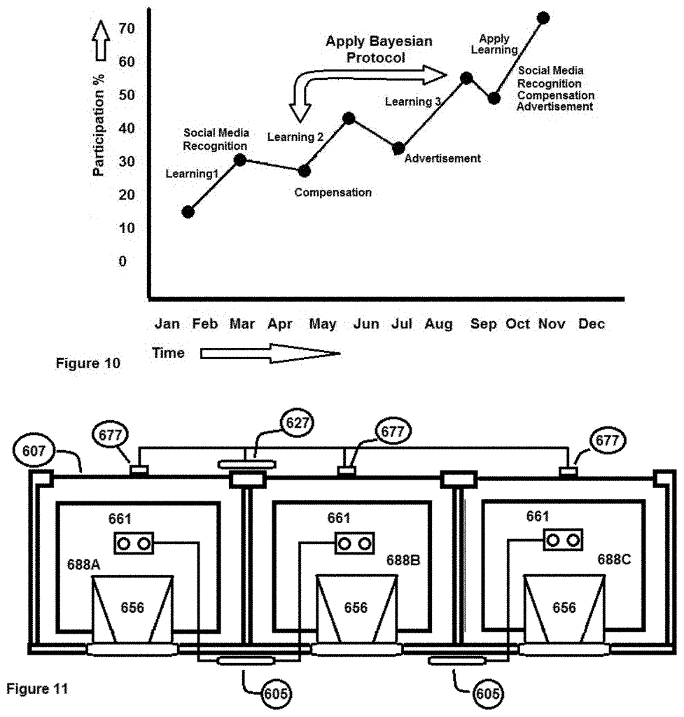

FIG. 11 is a portable or stationary recycling management structure (607) containing separate genre′ of bins (688A, 688B, 688C) respectively shown with secured hardware authorized electronic access (627) and electronic locking devices (677). The geo-locating hardware (605) is utilized to connect to a network (FIG. 9) to create geo-locating services of the recyclable waste and report it to a waste management and logistics center (FIG. 10). Each bin (688A, 688B, 688C) utilizes a “bin full” sensor (661) to determine capacity of said recycle bin (688A, 688B, 688C). Each bin representing different genre′ of recyclable waste with different fill levels determined by said fill sensors (661). The user electronic access device (605) operates a secured access portal (656) to grant access for pre-registered recycle participant first (1^{st}) user to discard recyclable waste.

What is claimed is:

1. A method of intelligent recycling where a first user is first registered in a computer network environment enrollment associating a means of biometric or electronic assigned association to said first user whereby said first user collects and distributes recyclable goods to a Second Compensation Provider participant of recyclable goods collector who in turn compensates said first user with an electronic currency reward enhanced through participation of a third user philanthropist and a fourth user participant goods and services provider who increases the value of said reward through increased exchange of goods and services in trade for accepting recyclable electronic currency.

2. The method of claim 1 where said computer network environment enrollment utilizes a database.

3. The method of claim 1 where said computer network environment enrollment utilizes DAT file storage.

4. The method of claim 1 where biometric association of said first user is stored as a Binary Large Object for storage and retrieval.

5. The method of claim 1 where electronic assigned association is smart card.

6. The method of claim 1 where electronic currency is compensation for recycling efforts of said first user.

7. The method of claim 1 where electronic currency is granted through Debit or Credit Card, electronic digital wallet or digital credit.

8. The method of claim 1 where recyclable goods includes Glass, Metal, Plastic, Paper and Biodegradable refuge or other recyclable materials.

9. The method of claim 1 where proper identification of said first user is associated with recyclable material deposited into containers belonging to a Second Compensation Provider participant so as to properly identify said first user as the recyclable material depositing agent.

10. The method of claim 9 where proper identification of said first user utilized a biometric conversion of said first user's uniquely identifiable traits so as to associate said deposit of recyclable container of materials with said first user account information.

11. The method of claim 10 where deposited material container contains sufficient embedded elements which can identify said container through electronic means.

12. The method of claim 11 where electronic means includes RFID.

13. The method of claim 11 where electronic means includes Ambient Backscatter device.

14. The method of claim 11 where electronic means includes QR Code optical identification.

15. The method of claim 11 where electronic means includes Barcode optical identification

16. An apparatus comprising means for properly identifying secondary containers being deposited by a first user as belonging to said first user distributed in a primary foldable device which once unfolded can interlock and provide electronically identified secondary container distribution elements.

17. The apparatus of claim 16 further comprising QR code registry which register secondary contents held within the said primary container distribution package.

18. The apparatus of claim 16 further comprising Bar code registry which register secondary contents held within the said primary container distribution package

19. The apparatus of claim 17 where secondary containers have embedded solutions which are registered from the primary container QR Code.

20. The apparatus of claim 17 where secondary containers have embedded solutions which are registered from the primary container Barcode.

21. The apparatus of claim 19 where secondary container utilizes an embedded electronic component which can be read through NFC

22. The apparatus of claim 19 where secondary container utilizes an embedded electronic component which can be read through RFID

23. An apparatus comprising means for compensation to a first user recycling participant by a Second Compensation Provider recyclable goods collector which utilizes a first measure of security sufficient to identify said first user, a second measure of security which identifies said first user's deposit as belonging to said first user, a third measure of security which identifies said contents of said first user deposit to match the selection of said deposit.

24. The apparatus of claim 23 where compensation is an Electronic currency based reward system.

25. The apparatus of claim 23 where first security measure is a participation account generation associated with said first user's biometric recording information thereby properly identifying said first user credentials in the intelligent recycling system.

26. The apparatus of claim 23 where second measure of security identifies deposit container being deposited and associated with said first user recycling participant.

27. The apparatus of claim 23 where third measure of security is hardware sufficient to identify contents of recyclable deposit to match the selection made by first user recycling participant.

28. The apparatus of claim 24 where Electronic currency reward system is stored in a blockchain to record transaction states between first user recycling participant and Second Compensation Provider recyclable goods collector.

29. The apparatus of claim 28 where states of Electronic currency blockchain are altered when a transaction of recycling materials are deposited.

30. The apparatus of claim 28 where states of Electronic currency blockchain are altered when a transaction of materials are purchased by said Second Compensation Provider.

31. The apparatus of claim 28 where states of Electronic currency blockchain are altered when a first user utilizes rewards belonging in their Electronic wallet to a fourth user participant offering goods and services in lieu of recycling reward Electronic currency.

32. The apparatus of claim 25 where account generation of first user biometrics is stored in a network computing system.

33. The apparatus of claim 29 where deposited secondary container information is stored in said network computing system.

34. The apparatus of claim 29 further comprising stored information of deposited material stored in network computing system.

35. A foldable collapsible primary container with sufficient markings to identify proper registration of secondary containers to belong to a first user recycling participant in a network computing system whereby said secondary containers are stored one inside the other so as to easily distribute each said secondary container individually so after removal of said secondary containers held within a collapsible primary container and distributed within each secondary container allows first user recycling deposits to be tracked between Second Compensation Provider collectors and recycling facilities who utilize recyclable materials for manufacturing.

36. The container of claim 35 where the foldable collapsible primary container is made of recycled paper.

37. The container of claim 35 where foldable collapsible primary container is made of recycled plastic.

38. The container of claim 35 where foldable collapsible primary container contains sufficient structural interlocking mechanisms to allow a first user to shape the said primary container into a self-standing recyclable material collection bin.

39. The container of claim 38 where self-standing recyclable material collection bin is registered to a first user recycling participant.

40. The container of claim 37 where registration of bin is comprised of an identifiable marking used in QR Code protocols.

41. The container of claim 40 where registration of bin is comprised of an identifiable marking used in Barcode protocols.

42. A method of a Second Compensation Provider to enhance first user recycling rewards through increasing the value through solicitation of environmental cleanup to a third user participant whereby said enhancements are stored in a network computing system and exchange between Second Compensation Provider collector and first user recycling participant reward is enhanced to increase participation of said recycling by first user recycling participants.

43. The method of claim 42 where participation of a plurality of third party users is tracked in a blockchain and stored on a network computing system to monitor transactions between first, second, third and fourth users in the proper recycling of recyclable goods.

44. The method of claim 42 where third party participant reward enhancer participation is stored in a network computing system providing Second Compensation Provider collector with more financial reward benefits to first user recycling participants.

45. An intelligent collection system whereby said first user is identified by biometrics and identified as said first user at a kiosk which controls collection bins above ground to open said collection bin door for discarding proper materials corresponding to the genre of specific bin's collection of recyclable materials through electronically identifiable waste containers which are distributed by said kiosk to said first user supplied by a Second Compensation Provider collection and to assure proper compensation of electronic currency is given to said first user for their participation in the intelligent recycling system.

46. The system of claim 45 where collection system is a plurality of raise able underground collection bins to allow more recyclable waste to be collected by said Second Compensation Provider.

47. The system of claim 46 where notification services are generated through recyclable bin capacity sensors which determine the capacity of the collection bin to be near full or completely full.

48. The system of claim 47 were notification services are SMS text messages.

49. The system of claim 47 where notification services are Email.

50. The system of claim 47 where notification services are an audible alarm.

51. The system of claim 47 where notification services are a visible alarm.

52. The system of claim 45 where biometric identification are facial recognition

53. The system of claim 45 where biometric identification is fingerprint.

54. The system of claim 45 where biometric is retina scan.

55. The system of claim 45 where bin door is electronically remotely controlled through a remote CPU.

56. The system of claim 55 where Remote CPU identifies proper first user through means of biometrics.

57. The system of claim 55 where CPU is located in a wireless network.

58. The system of claim 55 where CPU is located in a wired network.

59. The system of claim 45 further comprising of compensation of reward as monetary compensation to said first user is in the form of electronic currency.

60. The system of claim 59 where electronic currency is Crypto Currency

61. The system of claim 59 where electronic currency is Debit Card.

62. The system of claim 59 where electronic currency is Credit Card

63. A method to utilize recycling user statistics and apply Bayesian protocols of collected data feedback utilizing server based collection data model to adjust or alter strategies to improve recycling proclivity of social media registered recycling participants.

64. The method of claim 63 where said recycling user statistics includes recyclable waste genre of said recyclable waste being discarded by social media registered recycling participants.

65. The method of claim 64 where recycling user statistics includes weight of discarded material by said social media registered recycling participants.

66. The method of claim 64 where genre of recyclable waste is identified through an electronically identifiable flexible carbon based waste container.

67. The method of claim 66 where electronically identifiable flexible carbon based waste container utilizes a QR Code.

68. The method of claim 66 where electronically identifiable flexible carbon based waste container utilizes an RFID.

69. The method of claim 66 where electronically identifiable flexible carbon based waste container utilizes an NFC.

70. The method of claim 66 where electronically identifiable flexible carbon based waste container utilizes a UPC Label.

71. The method of claim 63 where recycling data feedback utilizing server based collection data model is a Bayesian Protocol.

72. The method of claim 71 where Bayesian Protocol data model is used to enhance or alter a registered recycling participant's participation through strategic generation of probability matrix improving proper recycling management.
